(19) United States
(12) Patent Application Publication
(10) Pub. No.: US 2005/0054303 A1
(43) Pub. Date: Mar. 10, 2005

(54) Open/closed detection for an electronic device

(76) Inventors: Jeppe Goltermann, Kastrup (DK); Steen Madsen, Frederikssund (DK); Carsten Elbaek Brandt, Virum (DK); Morten P. Pedersen, Koege (DK)

Correspondence Address: PERMAN & GREEN, 425 POST ROAD, FAIRFIELD, CT, 06824, US

(21) Appl. No.: 10/656,407

(22) Filed: Sep. 5, 2003

(51) Int. Cl. H04Q 7/20

(52) U.S. Cl. 455/90.3

(57) ABSTRACT

An electronic device has two parts than can be opened and closed. A speaker is located in one body part and a sensor, located in the other, detects when the body parts are closed by sensing the magnetic field of the speaker.

### FIELD OF THE INVENTION

The present invention relates to an electronic apparatus comprising first and second body portions movable between an open configuration and a closed configuration, a speaker having a permanent magnet in the first portion and a magnetic field sensor in the second portion.

### BACKGROUND TO THE INVENTION

Folding or “clamshell” type mobile phones are well known. Such mobile phones typically employ sensing means for determining whether the phone is in an ‘open’ or a ‘closed’ state. A conventional way of implementing such sensing means is by using a magnetic sensor and a dedicated permanent magnet.

In order to meet consumers' needs, there is an increasing need to reduce the size, cost and weight of mobile phones.

### SUMMARY OF THE INVENTION

According to the present invention there is provided an electronic apparatus comprising first and second body portions movable between an open configuration and a closed configuration, a speaker having a permanent magnet in the first portion and a magnetic field sensor in the second portion, wherein the magnetic field sensor is positioned so as to detect the magnetic field of the speaker when the apparatus is in its closed configuration.

According to the present invention there is also provided, a mobile communication apparatus comprising first and second body portions movable between an open configuration and a closed configuration, a speaker having a permanent magnet in the first portion and a magnetic field sensor in the second portion, wherein the magnetic field sensor is positioned so as to detect the magnetic field of the speaker when the apparatus is in its closed configuration.

The first and second body portions may be coupled by a hinge so that they can be pivoted between the first and second configurations.

Preferably, the apparatus comprises processing means operable in a first mode and a second mode, responsive to the output of the magnetic field sensor for switching between said mode in accordance with whether the apparatus is in its open or closed configuration. Even more preferably, the first mode a standby mode and the second mode an operational mode.

### BRIEF DESCRIPTION OF THE DRAWINGS

FIG. 1 illustrates an embodiment of a mobile phone according to the present invention.

FIG. 2 shows the mobile phone of FIG. 1 in a ‘closed’ position.

FIG. 3 shows the mobile phone of FIG. 1 in an ‘open’ position.

### DETAILED DESCRIPTION OF THE PREFERRED EMBODIMENTS

Embodiments of the present invention will now be described, by way of example, with reference to the accompanying drawings.

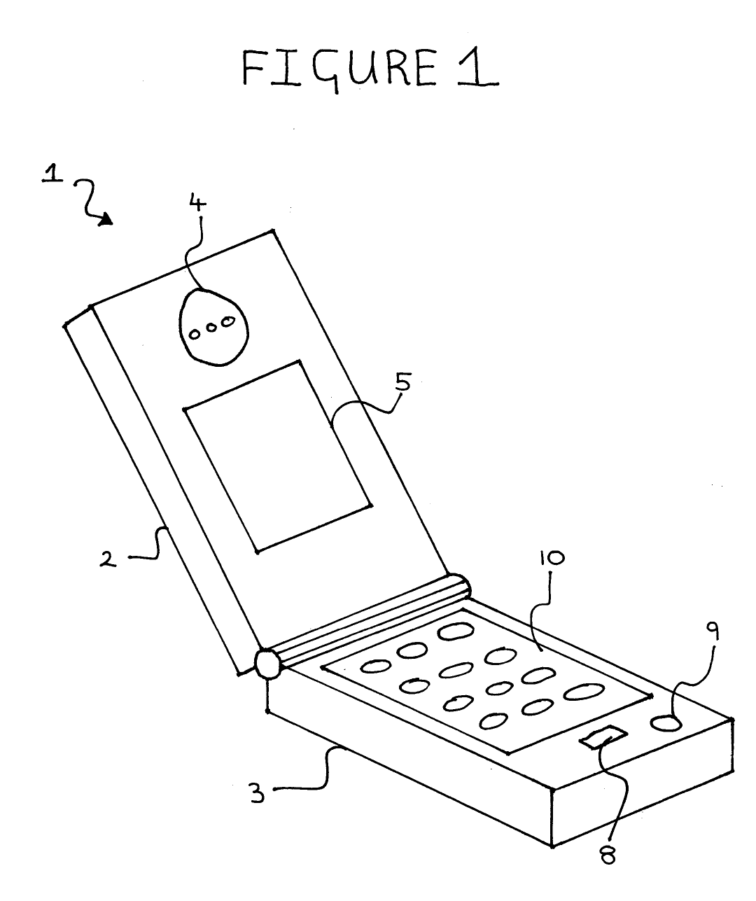

Referring to FIG. 1, a mobile phone 1 according to the present invention comprises a main body, having first and second portions 2, 3. The first and second portions 2, 3 are coupled by a hinge, such that they can be folded together into a closed position, in which the free ends of the first and second portions 2, 3 are in close proximity to one another, or opened out into an open position, in which the free ends of the first and second portions 2, 3 are spaced apart.

The first portion 2 is provided with a speaker 4 adjacent its free end, a display 5, an antenna 6 and RF circuitry 7. The second portion 3 is provided with a magnetic field sensor 8 adjacent to its free end, a microphone 9, a keypad 10 and processing means 11. The processing means 11 comprises circuitry for controlling the operations of the mobile phone 1. The display 5 is typically a liquid crystal display (LCD) and the magnetic field sensor 8 is typically a Hall effect sensor or a magneto-resistive sensor (MR). The speaker 4 is a moving coil device, which is well-known, and comprises a permanent magnet.

The speaker 4 receives an audio signal from the processing means 11 and outputs acoustic signals to a user. The display 5 receives an image signal from the processing means 11 and outputs information to a user, such as text and graphics. The microphone 9 generates an audio signal in response to a user's voice and outputs the signal to the processing means 11. The keypad 10 generates control signals in response to user input key presses and outputs the control signals to the processing means 11.

The RF circuitry receives RF signals from the antenna 6 and outputs the signals to the processing means 11 or receives signals from the processing means 11 and outputs the signals to the antenna 6. The antenna 6 transmits and receives RF signals to/from an external transceiver, such as a mobile phone network base station.

The magnetic field sensor 8 outputs a signal in response to the strength of the magnetic field which it detects.

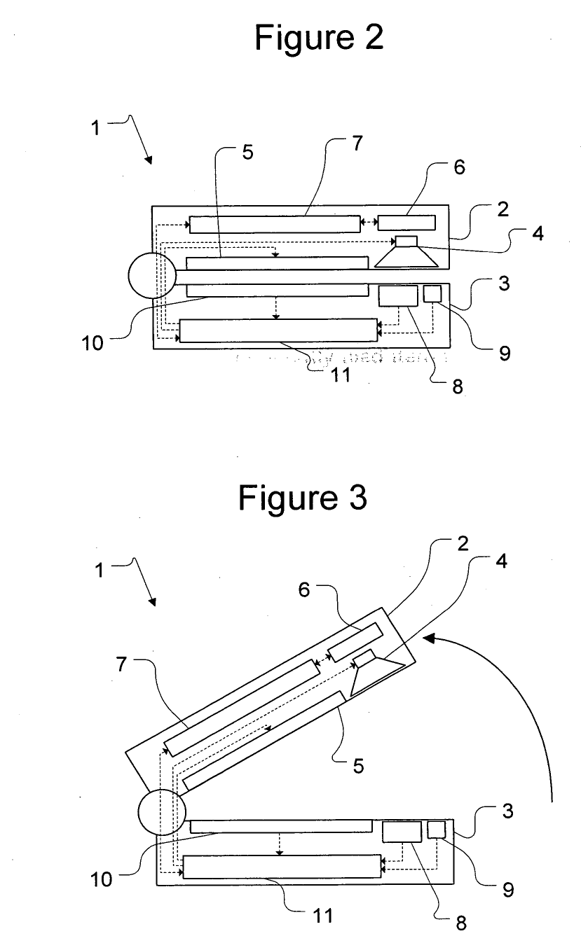

Referring to FIG. 2, when the phone is in the closed position the first and second portions 2, 3 of the main body are arranged substantially plane parallel to one another. In this configuration, the free ends of the first and second portions 2, 3 are adjacent to one another and thus, the speaker 4 is positioned adjacent to the magnetic sensor 8.

In this case, the magnetic sensor 8 detects the magnetic field of the permanent magnet in the speaker 4 and sends a signal to the processing means 11 corresponding to a ‘high’ magnetic field being detected. The processing means is configured so as to interpret the signal as corresponding to the phone 1 being in a closed position.

Referring to FIG. 3, when the phone 1 is opened by the user, by unfolding the first and second portions 2, 3 of the main body about the hinge, the free ends of the first and second portions 2, 3 are spaced apart from one another. Thus, the speaker 4 disposed in the first portion 2 is distanced from the magnetic sensor 8 disposed in the second portion 3. In this case, since the permanent magnet of the speaker 4 is no longer in close proximity to the magnetic sensor 8, the magnetic sensor 8 sends a signal to the processing means 11 corresponding to a ‘low’ magnetic field being detected. In this case the magnetic field is ‘low’ with respect to the magnetic field detected when the phone 1 is in the closed position. The processing means 11 is configured to interpret the ‘low’ magnetic field signal as corresponding to the phone 1 being in an open position.

In one embodiment, the mobile phone 1 has two modes of operation. The first mode is a standby mode in which no, reduced or intermittent power is supplied to certain elements of the phone 1 in order to reduce overall power consumption. The second mode is an operation mode in which power is typically supplied to all of the elements of the phone 1. When it is detected, by means of the magnetic field sensor 8 that the phone 1 is in a closed position, the processing means 11 is configured to put the phone in the standby mode. When it is detected, by means of the magnetic field sensor 8 that the phone 1 is in an open position, the processing means 11 is configured to put the phone in the operation mode.

In another embodiment of the present invention, when an incoming call is made to the phone 1, whilst the phone 1 is in the closed position, the call is answered when it is determined by the processing means 11, in response to a signal from the magnetic field sensor 8, that the phone 1 is manipulated, by a user, into the open position. Alternatively, a call may be ended when it is determined by the processing means 11, in response to a signal from the magnetic field sensor 8, that the phone 1 is manipulated, by a user, from an open state into a closed state.

As described above, a folding mobile phone having a speaker and a magnetic field sensor disposed in respective first and second portions thereof, in which an open or a closed position of the phone is determined in accordance with the strength of the magnetic field of the speaker detected by the magnetic sensor, is provided.

It is appreciated that whilst the above-described embodiment of the present invention is applied to a folding or “clamshell” type mobile phone in which the two main parts of the phone are hinged, the present invention could equally be applied to a mobile phone comprising two parts which are slidably attached to one another.

1. An electronic apparatus comprising:
first and second body portions movable between an open configuration and a closed configuration;
a speaker having a permanent magnet in the first portion; and
a magnetic field sensor in the second portion,
wherein the magnetic field sensor is positioned so as to detect the magnetic field of the speaker when the apparatus is in its closed configuration.

2. An apparatus according to claim 1, comprising an audio signal source connected to the speaker for driving the speaker to generate acoustic signals.

3. An apparatus according to claim 1, comprising processing means operable in a first mode and a second mode, responsive to the output of the magnetic field sensor for switching between said mode in accordance with whether the apparatus is in its open or closed configuration.

4. An apparatus according to claim 3, comprising an audio signal source connected to the speaker for driving the speaker to generate acoustic signals.

5. An apparatus according to claim 4, wherein the first mode is a standby mode and the second mode is an operational mode.

6. An electronic apparatus comprising:
first and second body portions coupled by a hinge and pivotable between an open configuration and a closed configuration;
a speaker having a permanent magnet in the first portion; and
a magnetic field sensor in the second portion,
wherein the magnetic field sensor is positioned so as to detect the magnetic field of the speaker when the apparatus is in its closed configuration.

7. An apparatus according to claim 6, comprising an audio signal source connected to the speaker for driving the speaker to generate acoustic signals.

8. An apparatus according to claim 6, comprising processing means operable in a first mode and a second mode, responsive to the output of the magnetic field sensor for switching between said mode in accordance with whether the apparatus is in its open or closed configuration.

9. An apparatus according to claim 8, comprising an audio signal source connected to the speaker for driving the speaker to generate acoustic signals.

10. An apparatus according to claim 9, wherein the first mode is a standby mode and the second mode is an operational mode.

11. A mobile communication apparatus comprising:
first and second body portions movable between an open configuration and a closed configuration;
a speaker having a permanent magnet in the first portion; and
a magnetic field sensor in the second portion,
wherein the magnetic field sensor is positioned so as to detect the magnetic field of the speaker when the apparatus is in its closed configuration.

12. An apparatus according to claim 11, comprising an audio signal source connected to the speaker for driving the speaker to generate acoustic signals.

13. An apparatus according to claim 11, comprising processing means operable in a first mode and a second mode, responsive to the output of the magnetic field sensor for switching between said mode in accordance with whether the apparatus is in its open or closed configuration.

14. An apparatus according to claim 13, comprising an audio signal source connected to the speaker for driving the speaker to generate acoustic signals.

15. An apparatus according to claim 14, wherein the first mode is a standby mode and the second mode is an operational mode.

16. An apparatus according to claim 15, wherein the processing means is configured to supply no, reduced or intermittent power to certain elements of the phone in the standby mode.

17. An electronic apparatus comprising:
first and second body portions coupled by a hinge and pivotable between an open configuration and a closed configuration;
a speaker having a permanent magnet in the first portion; and
a magnetic field sensor in the second portion,
wherein the magnetic field sensor is positioned so as to detect the magnetic field of the speaker when the apparatus is in its closed configuration.

18. An apparatus according to claim 17, comprising an audio signal source connected to the speaker for driving the speaker to generate acoustic signals.

19. An apparatus according to claim 17, comprising processing means operable in a first mode and a second mode, responsive to the output of the magnetic field sensor for switching between said mode in accordance with whether the apparatus is in its open or closed configuration.

20. An apparatus according to claim 19, comprising an audio signal source connected to the speaker for driving the speaker to generate acoustic signals.

21. An apparatus according to claim 20, wherein the first mode is a standby mode and the second mode is an operational mode.
